(19) United States
(12) Patent Application Publication
(10) Pub. No.: US 2024/0314608 A1
(43) Pub. Date: Sep. 19, 2024

(54) COORDINATED MEASUREMENT FRAMEWORK FOR A SUBNETWORK

(71) Applicant: Apple Inc., Cupertino, CA (US)

(72) Inventors: Dimitrios Alanis, Munich (DE); Ahmed Mohamed Ibrahim Hassan, Munich (DE); Sameh M Eldessoki, Munich (DE); Christian Hofmann, Muenche (DE); Panagiotis Botsinis, Munich (DE); Nikolai Bijovski Ribakov, Munich (DE); Said Medjkouh, San Diego, CA (US); Tarik Tabet, Carlsbad, CA (US)

(21) Appl. No.: 18/186,007

(22) Filed: Mar. 17, 2023

(51) Int. Cl. H04W 24/10; H04W 24/08

(52) U.S. Cl. CPC H04W 24/10; H04W 24/08

(57) ABSTRACT

Systems, methods, and circuitries are provided for coordinated measurement scheme for wireless communication devices in a subnetwork. In one aspect, a management node collects cell strength measurement data from reference devices in the subnetwork and broadcasts the cell strength measurement data to the subnetwork for use by the wireless communication devices within the subnetwork in generating cell strength measurement results. In another aspect, wireless network devices in the subnetwork receive cell strength measurement data generated by reference devices in the subnetwork and use a the received cell strength measurement data to generate a cells strength measurement result.

### BACKGROUND

The present disclosure relates generally to wireless communication and more specifically to techniques for coordinating measurements made by devices in a dense subnetwork.

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example wireless communication network that includes two subnetworks, in accordance with various aspects described.

FIG. 2 is a diagram of the example wireless communication network of FIG. 1 that indicates configured cell strength measurements, in accordance with various aspects described.

FIG. 3 is a diagram of an example cell strength measurement timeline, in accordance with various aspects described.

FIG. 4A illustrates an example message sequence for training a local measurement inference model based on received cell strength measurement data, in accordance with various aspects described.

FIG. 4B illustrates an example message sequence for using the local measurement inference model to generate inferred cell strength measurement data, in accordance with various aspects described.

FIG. 4C illustrates an example message sequence for refining cell strength measurement data with the inferred cell strength measurement data, in accordance with various aspects described.

FIG. 5A illustrates an exemplary training process for a local measurement inference model based on received cell strength measurement data, in accordance with various aspects described.

FIG. 5B illustrates an exemplary neural network, in accordance with various aspects described.

FIG. 6 illustrates an exemplary inference process for a local measurement inference model based on received cell strength measurement data, in accordance with various aspects described.

FIGS. 7A and 7B illustrate example cell strength measurement timelines for a reference device and a low capability device, respectively, in accordance with various aspects described.

FIG. 8 is a diagram of an example wireless communication network that includes two subnetworks that share cell strength measurement data, in accordance with various aspects described.

FIG. 9 is a flow diagram outlining an example method for acting as a management node in a subnetwork, in accordance with various aspects described.

FIG. 10 is a flow diagram outlining an example method for acting as a reference device in a subnetwork, in accordance with various aspects described.

FIG. 11 is a flow diagram outlining an example method for determining cell strength measurement result based on received cell strength information measured by reference devices in a subnetwork, in accordance with various aspects described.

FIG. 12 is a functional block diagram of a wireless communication network, in accordance with various aspects described.

FIG. 13 illustrates a simplified block diagram of a network device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

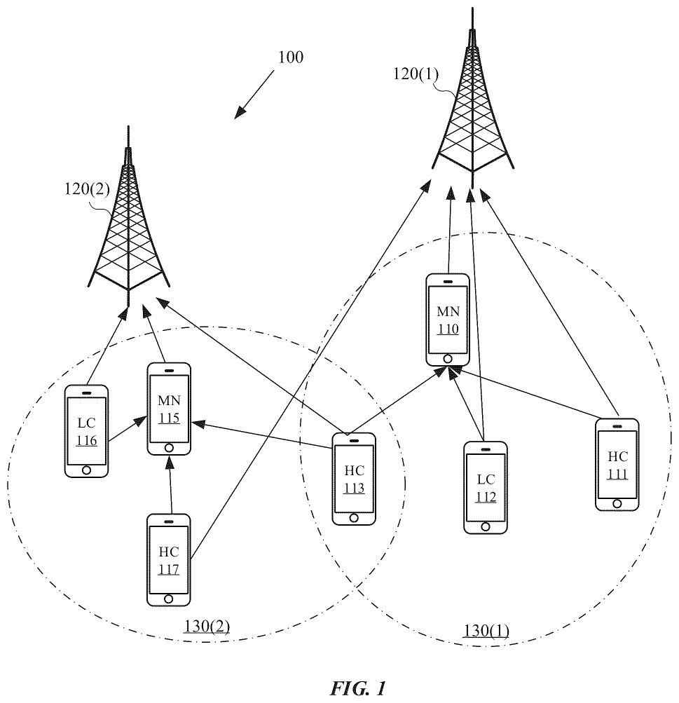

FIG. 1 illustrates an exemplary wireless communication network 100 that includes two base stations 120(1), 120(2) (e.g., evolved node B (eNB), next generation node B (gNB), transmission/reception point (TRP), and so on) and several wireless communication devices 110, 111, 112, 113, 115, 116, 117. The wireless communication devices are illustrated as user equipment (UE) cell phone devices, however the wireless communication devices may be any user-related device (e.g., wearable, virtual reality (VR) related, and so on) that is capable of connecting to a base station. The wireless communication devices are distributed in a dense network, meaning that the devices are in close proximity to one another. For example, the different wireless communication devices in the network 100 may be worn or carried by the same person, or by persons in a same room. From the perspective of the network 100, some of the wireless communication devices may be considered as co-located (e.g., having similar channel conditions or having a quasi-co-located type D (QCL-D) relationship).

The wireless communication devices 110, 111, 112, 117 are connected to a cell associated with base station 120(1) (e.g., in radio resource control (RRC) IDLE mode, RRC CONNECTED mode, or RRC INACTIVE mode) and the wireless communication devices 113, 115, 116 are connected to a cell associated with neighboring base station 120(2) (e.g., in RRC IDLE mode, RRC CONNECTED mode, or RRC INACTIVE mode). The different wireless communication devices may be connected to different base stations or cells due to a difference in a public land mobile networks (PLMNs) to which the different devices subscribe.

Sets of co-located wireless communication devices may establish a local subnetwork. In FIG. 1, devices 110, 111, 112, 113 form a first subnetwork 130(1) and devices 113, 115, 116, 117 form a second subnetwork 130(2). Each subnetwork is managed by a subnetwork management entity of one of the wireless communication devices. This wireless communication device is called a management node (MN) of the associated subnetwork. In some examples, the management node may be an access point (AP) with which the wireless communication devices communicate using cellular channels or a Wi-Fi direct channel (e.g., via a Wi-Fi protected setup (WPS) and/or Wi-Fi protected access (WPA/WPA2) security protocols). Wireless communication device 110 is the MN of subnetwork 130(1) and wireless communication device 115 is the MN of subnetwork 130(2). To form a subnetwork, an MN announces that it can act as an MN and indicates a set of capabilities that the MN can provide. The wireless communication devices search for available subnetworks, select a subnetwork to join, and join the subnetwork by synchronizing to the MN. A wireless communication device may join multiple subnetworks, as illustrated by wireless communication device 113, which belongs to both subnetworks 130(1) and 130(2).

The wireless communication devices in a subnetwork perform mutual authentication and maintain secured connections between the wireless devices in the subnetwork. The wireless communication devices may target forming a subnetwork with an MN having a low relative mobility with respect to the wireless device (e.g., traveling in the same vehicle, carried by a same pedestrian, in a same room). In some cases, a wireless communication device may disconnect from the base station when joining a subnetwork and communicate with the base station through the MN. In other examples, a wireless communication device may remain connected to a base station while also connected to an MN as a member of a subnetwork. The wireless communication devices in a subnetwork have a mechanism to communicate with each other (e.g., via sidelink or uplink to MN).

The wireless communication devices in the network 100 may have varying capabilities related to numbers of antennas, processor speed, processing features, battery life, and so on. In this disclosure, some wireless communication devices are designated as low capability (LC) devices while other devices are designated as high capability (HC) devices. The capability designations are general and intended to distinguish between “LC” devices that may, in some contexts, benefit from relying on measurements made by proximate “HC” devices to enhance operation (e.g., improve measurement accuracy, extend battery life, and so on). A device may be an HC device for some purposes and in some circumstances and a LC device in other circumstances (e.g., when in a low battery state). MNs may be HC devices. In the network 100, wireless communication devices 110, 111, 113, 115, 117 are HC devices and wireless communication devices 112, 116 are LC devices.

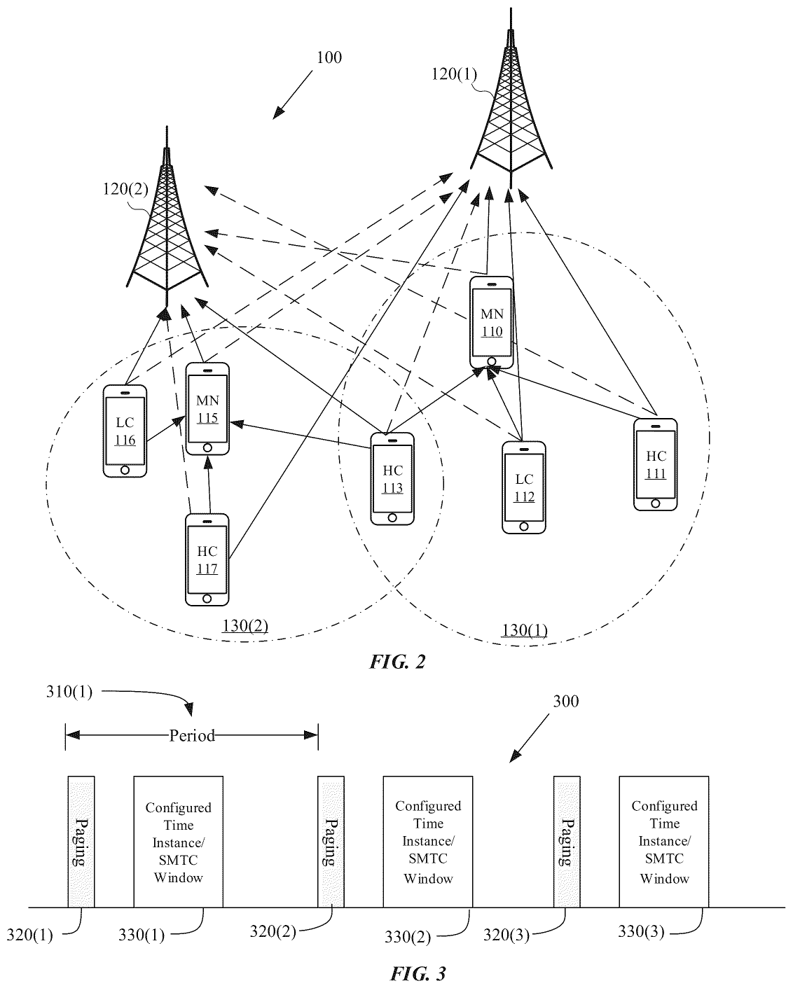

FIG. 2 illustrates cell strength (e.g., layer 3 (L3)) measurements that are made by the wireless communication devices in the network 100. Each wireless communication device is configured (e.g., by a serving base station and/or an MN) to make measurements of reference signals (e.g., synchronization signal block (SSB), channel state information reference signal (CSI-RS), and so on) from a serving base station (measurement shown in solid line) as well as reference signals from neighboring base stations (measurement shown in dashed line). Cell strength measurement data generated based on these measurements include signal to interference and noise (SINR) data, reference signal received power (RSRP) data, or reference signal received quality (RSRQ) data for one or more downlink beams of a serving base station and/or neighboring base stations. The MN may also transmit reference signals on one or more downlink beams for measurement by the wireless communication devices. The wireless communication devices in the subnetwork may measure the MN reference signals to generate cell strength measurement data for the various beams of the MN.

The wireless communication devices are able to distinguish a source (e.g., particular base station or MN) and beam (e.g., spatial layer) for each received reference signal. For example, a secondary synchronization signal (SSS) and a physical broadcast channel (PBCH) payload of a reference signal may be decoded by the wireless communication devices to identify the source and beam associated with the reference signal. In the example network 100, the wireless network devices measure reference signals from base station 120(1) either as a serving base station or a neighboring base station, base station 120(2) either as a serving base station or a neighboring base station, and MN 110 and/or MN 115 as a serving MN, depending on their respective subnetwork.

The configuration for reference signal measurement includes a periodicity (related to a length of time between measurements) with which the wireless communication device is to measure the configured reference signals. The periodicity may be dynamically configured depending on a mobility state of the wireless communication device, so that, for example, a higher periodicity (corresponding to longer time between measurements) may be configured for a stationary device and a lower periodicity (corresponding to a shorter time between measurements) may be configured for a fast moving device. Other factors that may determine the configuration of periodicity include the processing and battery-related capabilities of a device.

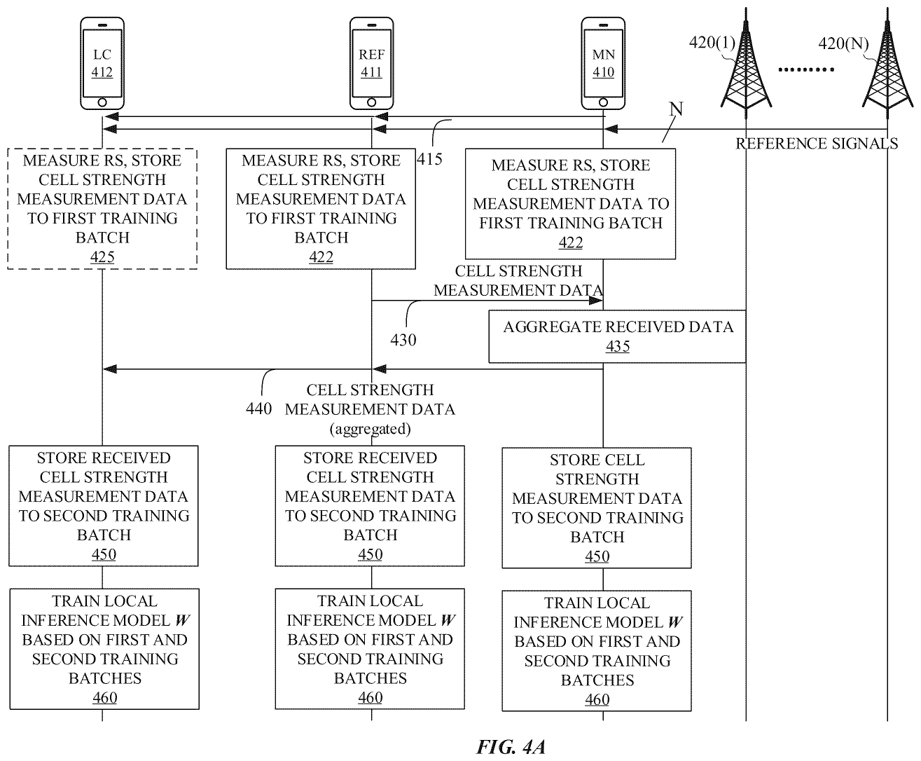

FIG. 3 illustrates a timeline of an example measurement configuration 300 for a wireless communication device. In one example, the measurement configuration is transmitted in an RRC MeasConfig information element that configures a period for measurement and, within each period, an offset and duration (in terms of slots or subframes) of an SSB-based radio resource management (RRM) measurement timing configuration (SMTC) window. Each measurement period begins with a paging period 320 for receiving paging messages followed, as configured, by an SMTC window 330. The wireless communication device measures SSBs or other reference signals during the SMTC window 330 to generate cell strength measurement data used for link monitoring purposes (e.g., cell re-selection, handover, serving beam changes, and so on). In FIG. 3, three configured time instances 330(1), 330(2), 330(3) are illustrated, each corresponding to an SMTC window during which the wireless communication device is configured to measure SSBs from the serving base station, and/or neighboring base stations, and/or a serving MN.

The wireless communication device may use cell strength measurement results that are based on the cell strength measurement data generated at the configured time instances (SMTC windows) to make internal decisions related to link management, such as determining a link failure and triggering a cell re-selection process. The wireless communication device may also be configured to periodically report cell strength measurement results back to the base station. The cell strength measurement results to be included in each report and a timing of the reporting is configurable. For example, a wireless communication device may be configured to make cell strength measurements every 40 milliseconds and report back an average reference signal received power (RSRP) value every 200 milliseconds, with the average RSRP being computed based on the most recent five measurements made at corresponding five configured time instances. In one example, the measurement report is configured by an RRC reportConfig information element. The measurement report may include, in an measResults information element, a sequence of cell strength measurement results (e.g., each result based on one or more instances of cell strength measurement data) for a corresponding sequence of measured SSBs.

Each cell strength measurement involves tuning the receiver of the wireless communication device to receive the reference signals from different base stations and/or MN and thus consumes a non-negligible amount of power. As can be seen in FIG. 2, devices that are in close proximity to one another (e.g., in a subnetwork or co-located) are making measurements of the same base stations and MNs. Since the devices are in close proximity to one another, the resources expended by each device to make the measurements may not be justified because the measured cell strength for closely located devices should be very similar. Further, some of the LC devices may opt for increased periodicity of cell strength measurements to conserve battery power, and suffer performance degradation. LC devices with a limited number of antennas may also make less accurate cell strength measurements than the HC devices in the subnetwork.

Described herein are systems, methods, and devices that support a coordinated measurement scheme for wireless communication devices in a subnetwork. In one aspect, a management node collects cell strength measurement data from reference devices (e.g., selected HC devices) in the subnetwork and broadcasts the cell strength measurement data to the subnetwork for use by the wireless communication devices within the subnetwork in generating cell strength measurement results. This enables the wireless communication devices to benefit, in terms of improved accuracy or increased measurement periodicity, from cell strength measurement data generated by the reference devices in a subnetwork.

In another aspect, wireless network devices in the subnetwork receive (e.g., via a broadcast message) cell strength measurement data generated by other devices in the network and use a measurement inference model to generate inferred cell strength measurement data. The inferred cell strength measurement data may be used as a substitute for the wireless communication device's own cell strength measurement data or to refine the wireless communication device's cell strength measurement data. This allows wireless communication devices in a subnetwork to increase the periodicity of cell strength measurements to reduce power consumption and/or improve the accuracy of the wireless communication device's own cell strength measurement data.

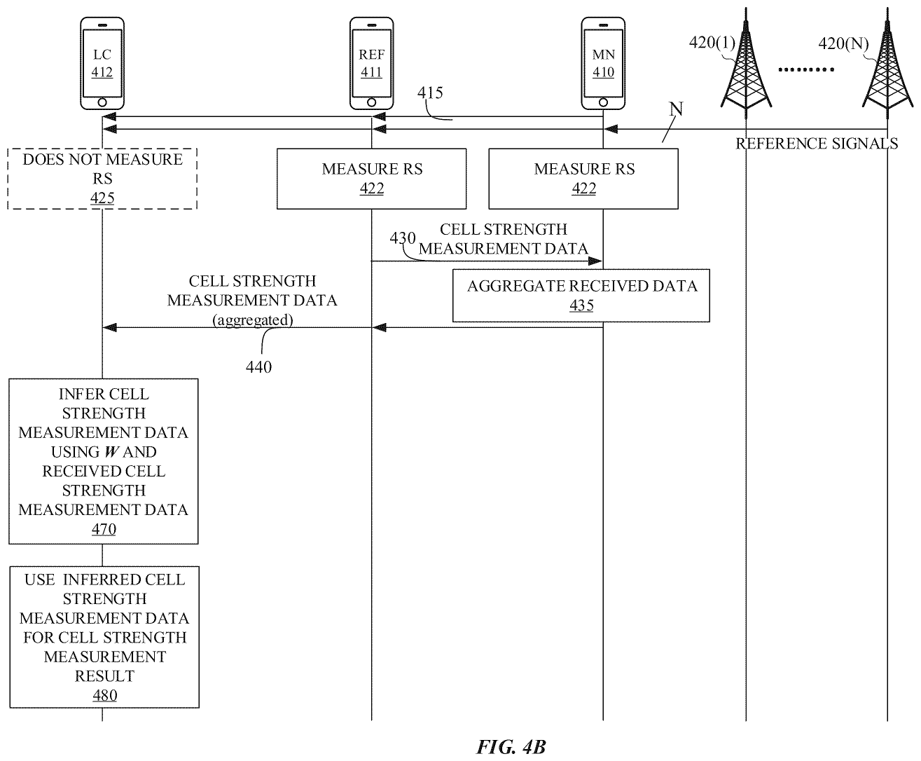

FIGS. 4A-4C are message flow diagrams outlining the functioning of wireless communication devices in an example subnetwork operating according to a training mode, an increased periodicity mode, and an increased accuracy mode, respectively. The subnetwork includes an MN 410 and a reference device 411, both of which may be HC devices and an LC device 412. Most subnetworks will include more reference devices, which will function analogously to reference device 411 and more LC devices, which will function analogously to LC device 412. The wireless communication devices 410,411,412 are each connected to one or more base stations 420(1)-420(N). The reference device 411 and the LC device 412 are connected to a single MN 410. Other devices may be connected to two or more MNs as illustrated with respect to HC device 113 of FIGS. 1 and 2. The messages and operations illustrated in each figure may be repeated at each configured cell strength measurement time instance.

### Sharing of Cell Strength Measurement Data

Referring to FIG. 4A, at a configured time instance, the N base stations and the MN transmit reference signals (RS) 415 and the reference signals are received by wireless communication devices in the subnetwork. At 422, the MN 410 and reference device 411 measure the RS to generate cell strength measurement data. Due to a higher periodicity of measurement, at some, but possibly not all, configured time instances, at 425 the LC device 412 measures the RS to generate cell strength measurement data. The MN 410, the reference device 411, and the LC device 412 store generated cell strength measurement data to a first training batch, for use in training a local measurement inference mode, as will be described with reference to 460.

The reference device 411 transmits a message 430 encapsulating cell strength measurement data. The cell strength measurement data may include, for example, L3 data including SINR, RSRP, RSRQ, and so on for downlink beams of a serving base station, neighboring base stations, and/or the MN 410. The message 430 may include a device identifier ID and/or a subnetwork ID. The device ID and/or the subnetwork ID may be anonymized and unique for each subnetwork. The message may include cell strength measurement results corresponding to respective RRC parameters that configure the measurement results (IE MeasResults) of the device as per 3GPP standard. The message may also indicate a mobility state of the device. In one example, the message 430 includes an information element MeasResultsDev configured as follows.

| MeasResultsDev::= | SEQUENCE { | |
|---|---|---|
| devID | INTEGER (0..255), | |
| subNetId | INTEGER (0..15), | |
| MeasResults | MeasResults, | |
| MobilityState | ENUMERATED {stationary, normal, medium, high, spare} | OPTIONAL |

}

The message 430 may be transmitted to the MN using a dedicated message through a physical uplink shared channel (PUSCH),a physical sidelink shared channel (PSSCH), or via connection established according to a WiFi related protocol. Other channels may be used to transmit message 430. At 435 the MN 410 aggregates the cell strength measurement data received in messages 430 from multiple reference devices. In broadcast message 440, the MN communicates the aggregated cell strength measurement data of the reference devices to the subnetwork. In one example, the message 440 is a sequence of cell strength measurement results from each reference device, including the elements disclosed above. The message 440 may be periodically broadcast by way of a dedicated system information block (SIB) via a PDSCH, PSSCH, or a WiFi channel. The message 440 may also include cell strength measurement data generated by the MN 410. In one example, the message 440 includes an information element MeasResultsSubnet configured as follows.
MeasResultsSubnet::=SEQUENCE (1 . . . numDevices) OF MeasResultsDev.
   The parameter numDevices refers to the number of reference devices (which may include the MN 410) whose results are being reported.

At 450, the reference device 411 and the LC device 412 store the received cell strength measurement data to a second training batch. The MN 410 may also store the aggregated received cell strength measurement data to a second training batch. Through the receiving of cell strength measurement data from reference devices and the broadcasting of aggregated cell strength measurement data for references devices, the MN provides low periodicity, highly accurate cell strength measurement data from co-located wireless communication devices for use by all wireless communication devices in a subnetwork to improve or replace their own measurements.

### Local Measurement Inference Model

The wireless communication devices in a subnetwork can leverage the received cell strength measurement data in message 440 to enhance operation by using a local measurement inference model to infer cell strength measurement data based on the received cell strength measurement data. In the illustrated examples, the cell strength measurement data for the reference devices is received via the broadcast message 440, however, in other examples, the cell strength measurement data for the reference devices may be received in another manner.

At 460, each device in the subnetwork trains its own local measurement inference model based on the first training batch (which includes the device's own measurements taken during a training interval) and the second training batch (which includes the received aggregated cell strength measurement data of the reference devices taken during the training interval).

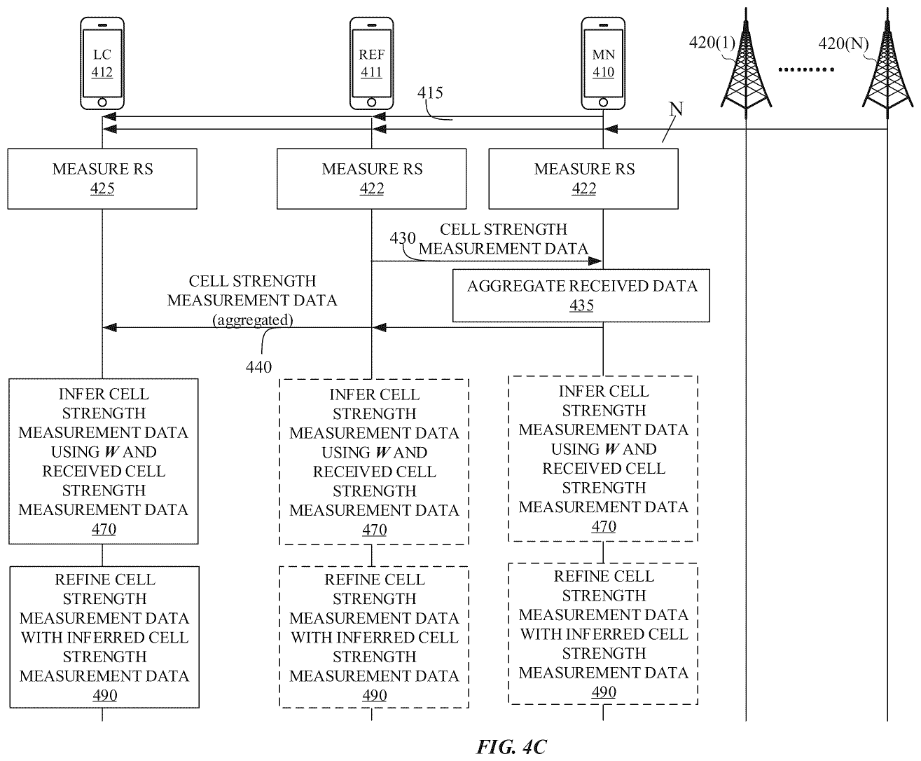

FIG. 5A illustrates an example training system 500 that may be employed by a wireless communication device to train a measurement inference model W (indicated generally as 560). In one example, the measurement inference model is linear in nature and includes a set of weights Wₙ⁽ⁱ⁾ such that

$${Y}^{( i )} = {W}_{1}^{( i )} {M}_{1} + {W}_{2}^{( i )} {M}_{2} + … + {W}_{N}^{( i )} {M}_{N} \qquad EQ . 1$$

During the training process, the weights Wₙ⁽ⁱ⁾ are computed by presenting the first training batch 510 and the second training batch 520 to the training system 500. In one example, the first and/or second training batches are compiled using a first in first out scheme in which a certain number of most recent cell strength measurements are stored in the batch, with an oldest measurement being replaced by a newest measurement. The device whose inference model is under consideration is designated as the i^{th} device herein. X is cell strength measurement data and may be RSRP, RSRQ, SINR, another L3 measurement, or any other cell strength related measurement. The first training batch 510 or Y(P includes the device's own measurements made at configured time instances during the training interval.

$${Y}^{( i )} = [ {X}_{BS 1 , beam 1}^{( i )} , {X}_{BS 1 , beam 2}^{( i )} , … {X}_{BSN , beam 1}^{( i )} , … {X}_{MN 1 , beam 1}^{( i )} … ]$$

The second training batch 520 includes cell strength measurement data from each reference device 1-N. The cell strength measurement data for a reference device n can be described as follows.

$${M}_{n} = [ {X}_{BS 1 , beam 1}^{( n )} , {X}_{BS 1 , beam 2}^{( n )} , … {X}_{BSN , beam 1}^{( n )} , … {X}_{MN 1 , beam 1}^{( n )} … ]$$

The corresponding (in terms of time instance of measurement) cell strength measurement data from the second batch 520(1)-520(N) are presented to a template or previously trained measurement inference model 560 which applies weights 530 to the cell strength measurement data and sums, using summing operator 540, the weighted cell strength measurement data to generate inferred cell strength measurement data P). An error is computed, using difference operator 550, between the inferred cell strength measurement data Ŷ⁽ⁱ⁾ and the corresponding (in terms of time instance of measurement) cell strength measurement data Y⁽ⁱ⁾. Recall that the first training batch may not include a same number of cell strength measurement data due to increased measurement periodicity of an LC device. In this case, the cell strength measurement data for a closest time instance to the time instance under consideration is used in the error computation for the time instance. As cell strength measurement data in the first and second batches is presented to the measurement inference model 560, the weights are successively adjusted in a manner that reduces the error. The measurement inference model W converges when the error is minimized. In one example, the error e is computed as follows.

$${e}^{i} = \sqrt{{\vert {Y}^{( i )} - {\hat{Y}}^{( i )} \vert}_{2}} \qquad EQ . 2$$

where |⋅|₂ corresponds to the power-2 norm. The mean square error (MSE) could be minimized (MMSE) instead to ensure convexity when the measurement inference model 560 is linear. A gradient descent method may be used to solve the MMSE problem.

In one example, the inference model 560 includes a neural network. FIG. 5B is a diagram of an example neural network (NN) 565 according to one or more implementations described herein. As shown, NN 565 may include nodes arranged in different layers, such as an input layer 570 of nodes, multiple hidden or intermediary layers 580 of nodes, and an output layer 590 of nodes. The illustrated NN includes only four input nodes, however the number of input nodes is adjusted based on the number of measurements (e.g., a sum of the number of measured beams per serving base station, neighboring base station, serving MN, and neighboring MN(s)) being used to determine the inferred cell strength measurement data.

Example NN 565 may include a number N of inputs introduced to four input nodes [N, 4] of input layer 570. This may include processing or encoding input data into a form, shape, vector, or data structure, that is receivable by the NN. The four input nodes may process the inputs to produce a first weight (W1) that the four input nodes provide to the five nodes [4;5] of a first hidden layer. The five nodes of the first hidden layer may use a first function (f1) to process the inputs to produce a second weight (W2) that the five nodes of the first hidden layer may provide to the five nodes [5;5] of a second hidden layer. The five nodes of the second layer may use a second function (f2) to process the inputs to produce a third weight (W3) that the five nodes of the second hidden layer may provide to a single node of output layer 590. The node of output layer 590 produces the inferred cell strength measurement data Ŷ⁽ⁱ⁾. This may include converting or decoding output data from a form, shape, vector, or data structure, that may be used by a subsequent algorithm, process, or procedure.

When a NN is used in the measurement inference model, the corresponding (in terms of time instance of measurement) cell strength measurement data from the second batch 520(1)-520(N) are presented to the input nodes 540 of the input layer 570 of a template or previously trained NN to generate inferred cell strength measurement data Ŷ⁽ⁱ⁾. An error is computed between the inferred cell strength measurement data Ŷ⁽ⁱ⁾ and the corresponding (in terms of time instance of measurement) cell strength measurement data Y⁽ⁱ⁾. As cell strength measurement data in the first and second batches is presented to the NN 565, the weights 530 are successively adjusted in a manner that reduces the error. The measurement inference model W converges when the error is minimized.

It is noted that the training processes disclosed with reference to FIGS. 5A and 5B are just examples. Each wireless communication device in a subnetwork trains and maintains a local (potentially different) measurement inference model using a local (potentially different) training technique. The number of cell strength measurements in the training batches may be configured based on a mobility state of the device (e.g., cell strength measurement data for more time instances is used when the device is more mobile). The training process may be repeated periodically, or in response to some triggering event (e.g., significant movement of the wireless communication device), to adjust and maintain the accuracy of a previously trained measurement inference model.

### Inferred Cell Strength Measurements for Increased Measurement Periodicity

LC devices that leverage received cell strength measurement data from reference devices may operate in an increased measurement periodicity mode (see FIG. 4B) and/or an increased measurement accuracy mode (see FIG. 4C). The LC devices may switch between operating modes on an ad hoc basis based on, for example, mobility status, power level, and so on. In some examples, the MN may control the operating mode of the LC devices in a subnetwork.

Referring to FIG. 4B, the subnetwork of FIG. 4A is illustrated in which the LC device 412 is operating in an exemplary increased measurement periodicity mode. The MN 410, reference device 411, and LC device 412 each host a trained local measurement inference model. As described in more detail with reference to FIG. 4A, in each time instance, the RS are transmitted at 415 and cell strength measurements are made at 422 by the reference device 411 and the MN 410. In this time instance, as indicated at 425, a cell strength measurement is not made by LC device 412. The reference device 411 transmits its cell strength measurement data via message 430 and the MN 410 broadcasts aggregated received cell strength measurement data via message 440.

At 470, the LC device 412 provides the received cell strength measurement data to the local measurement inference model to generate inferred cell strength measurement data. At 480, the LC device 412 uses the inferred cell strength measurement data to generate a cell strength measurement result for this time instance. The cell strength measurement result may be an SINR, RSRP, RSRQ, and so on, that is used by the LC device 412 to make internal link management decisions or to provide in measurement reporting to a base station. In other words, the LC device 412 substitutes the inferred cell measurement data for a measurement made by the LC device itself. Thus, in this configured measurement time instance, the LC device 412 conserves the power that would be expended in making a cell strength measurement.

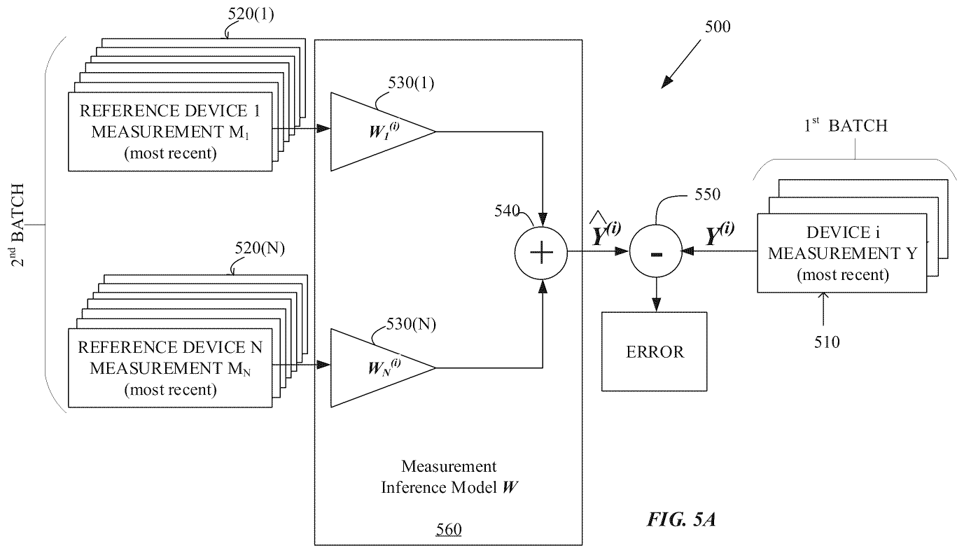

FIG. 6 is a functional block diagram outlining an exemplary process used by a LC device to perform operations associated with 470 and 480 in FIG. 4B. In 470, cell strength measurement data for reference devices 1-N is input to the trained measurement inference model 560 to generate the inferred cell measurement data. It is noted that this inferred cell strength measurement data may be inferred at a reference periodicity P while the LC device performs cell strength measurements at an increased periodicity (e.g., (2, 3, . . . )P). At 480, the inferred cell strength measurement data is used as a cell strength measurement result by the LC device. In this manner, the LC device can conserve power by increasing the periodicity of its cell strength measurements while still generating accurate (based on inference) cell strength measurement results.

### Inferred Cell Strength Measurements for Increased Measurement Accuracy

Referring to FIG. 4C, the subnetwork of FIG. 4A is illustrated in which the LC device 412 is operating in an exemplary increased measurement accuracy mode. The MN 410, reference device 411, and LC device 412 each host a trained local measurement inference model. As described in more detail with reference to FIG. 4A, in each time instance, the RS are transmitted at 415 and cell strength measurements are made at 422 by the reference device 411 and the MN 410. In this time instance, as indicated at 425, a cell strength measurement is made by LC device 412. The reference device 411 transmits its cell strength measurement data via message 430 and the MN 410 broadcasts aggregated received cell strength measurement data via message 440.

At 470, the LC device 412 provides the received cell strength measurement data to the local measurement inference model to generate inferred cell strength measurement data. At 490, the LC device 412 uses the inferred cell strength measurement data to refine its own cell strength measurement data to generate a cell strength measurement result for this time instance. The cell strength measurement result may be an SINR, RSRP, RSRQ, and so on, that is used by the LC device 412 to make internal link management decisions or to provide in measurement reporting to a base station. In other words, the LC device 412 refines the (possibly lower accuracy) measurement made by the LC device itself using the inferred cell measurement data. Thus, in this time instance, the LC device 412 likely improves the accuracy of its cell strength measurement result.

Referring to FIG. 6, an exemplary process used by a LC device to perform operations associated with 470 and 490 in FIG. 4C is illustrated. In 470, cell strength measurement data for reference devices 1-N is input to the trained measurement inference model 560 to generate the inferred cell measurement data. It is noted that this inferred cell strength measurement data may be inferred at a reference periodicity P while the LC device performs cell strength measurements at an increased periodicity (e.g., (2, 3, . . . )P). At 490, the inferred cell strength measurement data is used by the LC device to refine the cell strength measurement data to generate the cell strength measurement result. The MN 410 and/or the reference device 411 may also refine their respective cell strength measurement data at 490 to generate a cell strength measurement result. In the example illustrated in FIG. 6, a refinement weight W₀, which may be a bias parameter selected by each UE, is applied to the cell strength measurement data of the LC device for a most recent time instance and a difference between 1 and the refinement weight W₀ is applied to the inferred cell strength measurement data control. The weighted results are combined to generate the refined cell strength measurement data for the time instance. In one example W₀∈(0,1) such that the refinement process resembles the structure of a finite impulse response (FIR) filter.

In this manner, the LC device can improve the accuracy of its cell strength measurements by leveraging the improved accuracy and increased periodicity of the reference device cell strength measurements. This may improve link-based decisions and measurement reports made by the LC device.

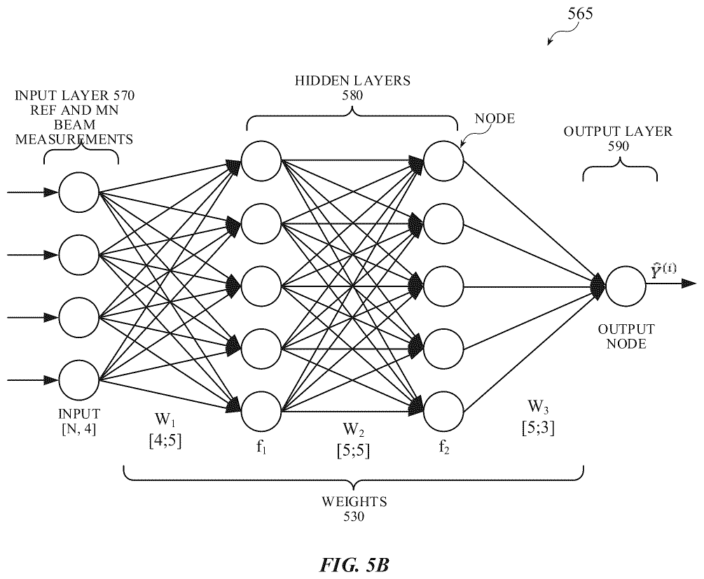

FIGS. 7A and 7B illustrate exemplary measurement timelines for a reference device and an LC device, respectively, in a coordinated measurement scheme in accordance with some aspects. As discussed with reference to FIG. 3, the wireless communication devices are configured with measurement time instances having a given periodicity P. Each measurement period includes an enhanced paging portion 720′ that includes additional time for transmission of the cell strength measurement data by the MN (e.g., time for transmitting a new SIB that includes aggregated cell strength measurement data (CSMD)). Each measurement period includes a configured SMTC window 730 during which a wireless communication device can measure reference signals from a serving base station and/or neighboring base station(s).

Referring to FIG. 7A, in each configured measurement period, the reference device receives the cell strength measurement data from the MN during a paging portion 720′ and performs a measurement during a configured SMTC window 730. The reference device uses the cell strength measurement data to generate inferred cell strength measurement data. The reference device refines its cell strength measurement data with the inferred cell strength measurement data to generate an enhanced cell strength measurement result. In other examples, the reference device (e.g., a fixed, HC device) does not host an inference model or refine its measurements based on broadcast cell strength measurement data.

As shown in FIG. 7B, the LC device alternates operation between the increased periodicity mode (see FIGS. 4B and 6) and the increased accuracy mode (see FIGS. 4C and 6). The LC device re-configures its measurement periodicity to a multiple of the configured periodicity P (2P in the illustrated example) based on information from the MN or the LC device's battery state, mobility state, or some other factor. Thus, in the illustrated example the LC device will make measurements at half the configured rate. In a first configured measurement period, during paging portion 720′(1), the LC device receives the CSMD SIB encapsulating the cell strength measurement data. The LC device uses the cell strength measurement data to generate inferred cell strength measurement data. During the first SMTC window 730(1), the LC device makes cell strength measurements to generate its own cell strength measurement data. The LC device refines its cell strength measurement data with the inferred cell strength measurement data to generate a cell strength measurement result. Thus, in the first configured measurement period, the LC device is operating in the increased accuracy mode.

In a second configured measurement period, during paging portion 720′(2), the LC device receives the CSMD SIB encapsulating the cell strength measurement data. The LC device uses the cell strength measurement data to generate inferred cell strength measurement data. During the second SMTC window 730(1), the LC device does not make cell strength measurements. The LC uses the inferred cell strength measurement data to generate a cell strength measurement result for this configured measurement time instance. Thus, in the second configured measurement period, the LC device is operating in the increased periodicity mode.

As can be seen in FIG. 7B, the LC device benefits from improved accuracy in configured measurement time instances in which the LC device makes measurements and from decreased power consumption with reasonably accurate inferred cell strength measurement results in configured measurement time instances in which the LC device refrains from making measurements.

### Extended Subnetwork Measurement Collaboration

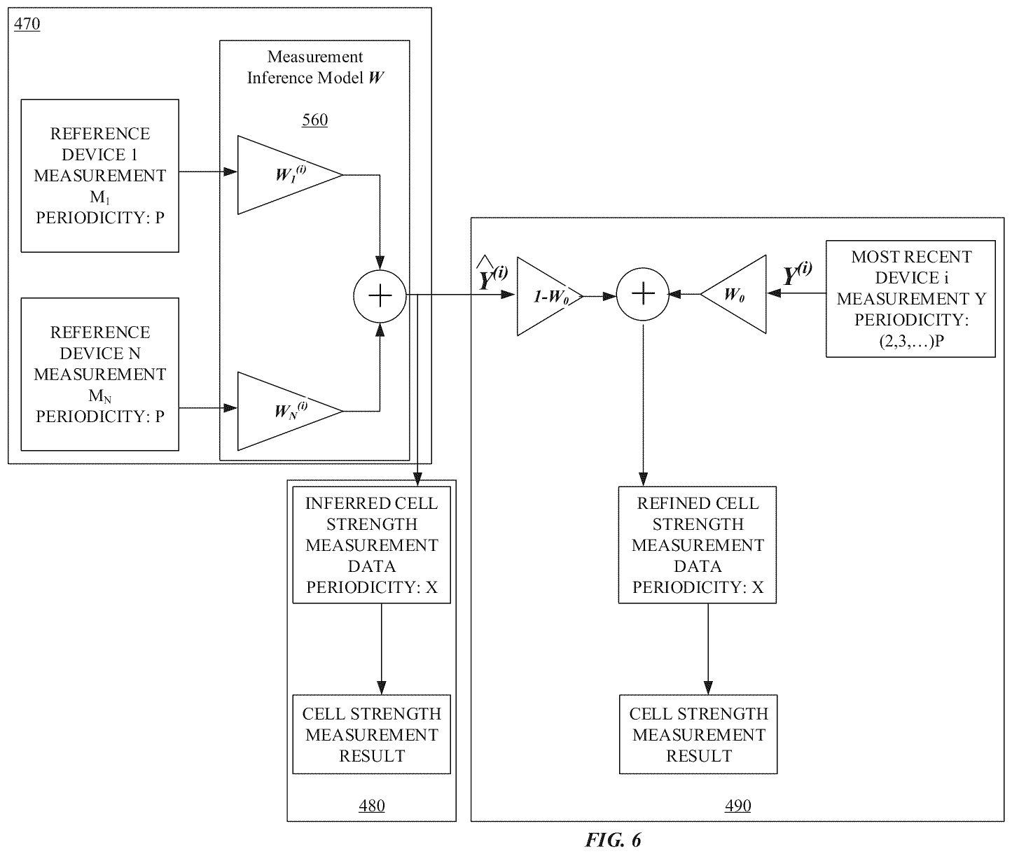

FIG. 8 illustrates an example subnetwork in which MN 810 and MN 815 are configured to establish a trusted overlay subnetwork (e.g., an inter-MN connection). The MN 810 and MN 815 communicate the cell strength measurement data for their respective subnetworks to each other. The MN 810 and MN 815 can then broadcast cell strength measurement data for reference devices in both subnetworks, allowing LC devices in each subnetwork to benefit from cell strength measurement data from an increased number of reference devices.

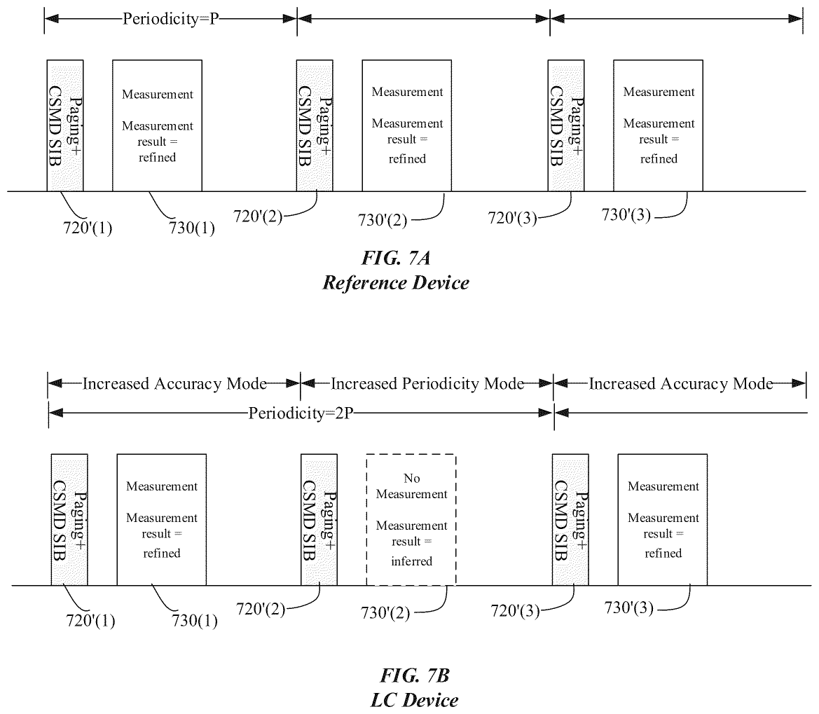

FIG. 9 is a flow diagram outlining an example method 900 for acting as a management node in a subnetwork. The method 900 may be performed, for example, by MN 110 and/or 115 of FIGS. 1-4, and/or MN 810 and/or 815 of FIG. 8. The method includes, at 910, receiving cell strength measurement data from one or more reference devices belonging to the subnetwork. Additional details about one example of operations that may be associated with 910 are disclosed herein with reference to message 430 of FIGS. 4A-4C.

The cell strength measurement data received at 910 may include signal to interference and noise (SINR) data, reference signal received power (RSRP) data, or reference signal received quality (RSRQ) data for one or more downlink beams of a serving base station and/or a neighboring base station of a respective reference device and/or a management node of a serving MN and/or a MN of a neighboring subnetwork (see FIG. 8).

The cell strength measurement data received at 910 may be received via a radio resource control (RRC) layer message that includes a MeasResults information element (IE) that indicates the cell strength measurement data. The cell strength measurement data received at 910 may be received via PUSCH, PSSCH, or a WiFi channel.

In one example, the method 900 includes aggregating the cell strength measurement data received from the one or more reference devices.

At 920, the method includes broadcasting the received cell strength measurement data within the subnetwork. Additional details about one example of operations that may be associated with 920 are disclosed herein with reference to message 440 of FIGS. 4A-4C. The method may include broadcasting a system information block (SIB) that indicates the cell strength measurement data. The broadcast message may include an identification of respective measurement devices associated with respective cell strength measurement data. The identification may include an anonymized subnetwork identifier.

In one example, the method 900 includes determining a respective mobility state for the respective reference devices based on the respective cell strength measurement data. In this example, the broadcast message may indicate a respective mobility state of respective measurement devices associated with respective cell strength measurement data. The method may include controlling a periodicity of the broadcasting of the received cell strength measurement data within the subnetwork based on a respective mobility state of the respective reference devices.

In one example, the method 900 includes receiving cell strength measurement data from another wireless communication device acting as a management node for a different subnetwork; and broadcasting the received cell strength measurement data within the subnetwork. Additional details about one example of operations that may be associated with this optional step are disclosed herein with reference to FIG. 8.

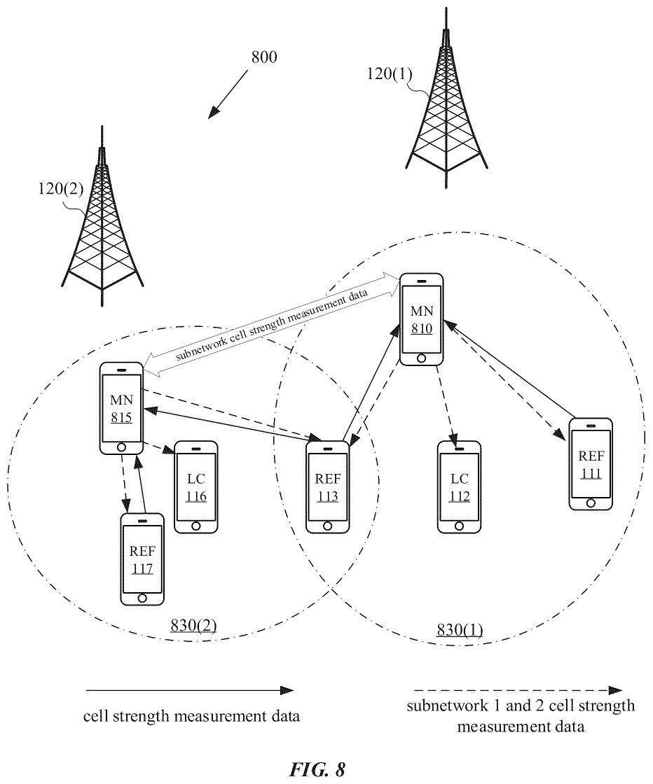

FIG. 10 is a flow diagram outlining an example method 1000 for a user equipment (UE) acting as a reference device as described with respect to FIGS. 1-8. The method 1000 may be performed, for example, by UEs 111, 113, 117 of FIG. 1, 2, or 8 and/or UE 411 of FIGS. 4A-4C. At 1010, the method includes measuring reference signals transmitted by one or more base stations to generate cell strength measurement data. Additional details about one example of operations that may be associated with 1010 are disclosed herein with reference to RS 415 and operation 422 of FIGS. 4A-4C as well as FIG. 7A.

The cell strength measurement data is transmitted to the MN at 1020. Additional details about one example of operations that may be associated with 1020 are disclosed herein with reference to message 430 of FIGS. 4A-4C.

The cell strength measurement data transmitted at 1010 may include signal to interference and noise (SINR) data, reference signal received power (RSRP) data, or reference signal received quality (RSRQ) data for one or more downlink beams of a serving base station and/or a neighboring base station of a respective reference device. The cell strength measurement data transmitted at 1020 may be transmitted via a radio resource control (RRC) layer message that includes a MeasResults information element (IE) that indicates the cell strength measurement data. The cell strength measurement data transmitted at 1020 may be transmitted via a PUSCH, or PSSCH, or a WiFi channel.

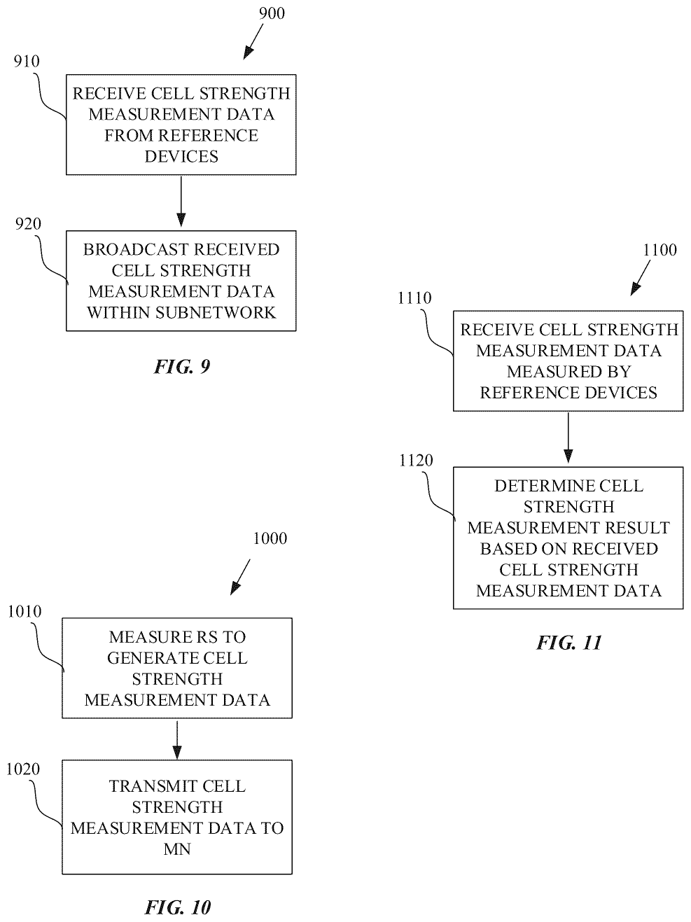

FIG. 11 is a flow diagram outlining an example method 1100 for determining a cell strength measurement result based on cell strength measurement data for reference devices as described with reference to FIGS. 1-8. The method 1100 may be performed, for example, by LC devices 112, 116 of FIG. 1, 2, or 8 and/or LC device 412 of FIGS. 4A-4C. The method includes, at 1110, receiving cell strength measurement data representing cell strength measured by reference devices in a same or neighboring subnetwork as the UE. Additional details about one example of operations that may be associated with 1110 are disclosed herein with reference to message 440 of FIGS. 4A-4C.

In one example, the method includes receiving a broadcast message that includes the cell strength measurement data. The cell strength measurement data received at 1110 may include signal to interference and noise (SINR) data, reference signal received power (RSRP) data, or reference signal received quality (RSRQ) data for one or more downlink beams of a serving base station and/or a neighboring base station of a respective reference device and/or a management node of a serving MN and/or a MN of a neighboring subnetwork (see FIG. 8). The cell strength measurement data received at 1110 may be received via a radio resource control (RRC) layer message that includes a MeasResults information element (IE) that indicates the cell strength measurement data. The cell strength measurement data received at 1110 may be received via a physical uplink shared channel (PUSCH), a physical sidelink shared channel (PSSCH), or a WiFi channel.

The method includes, at 1120, determining a cell strength measurement result for the UE based on the received cell strength measurement data. Additional details about one example of operations that may be associated with 1110 are disclosed herein with reference to operations 470 and 480 of FIG. 4B and or operations 470 and 490 of FIG. 4C, as well as FIGS. 6 and 7B.

In one example, an inference model is used to generate the cell strength measurement result. Additional details about one example of operations that may be associated with this optional step are disclosed herein with reference to FIGS. 4A, 5A, and 5B. In this example, the method includes training a local measurement inference model by, at a plurality of training time instances, measuring reference signals from one or more base stations to generate respective cell strength measurement data (e.g., operation 425 of FIG. 4A, the first batch of training data). The method includes receiving a training set of cell strength measurement data that includes respective cell strength measurement data generated by respective reference devices at the plurality of training time instances (e.g., the second batch of FIG. 4A). The method includes training the measurement inference model based on the training set of cell strength measurement data and the generated cell strength measurement data (e.g., operation 460 of FIG. 4A and FIG. 5).

The method 1100 may include operating in an increased periodicity mode or an increased accuracy mode, one example of which is illustrated in FIG. 7B. In this example, the method includes receiving configuration for performing respective cell strength measurements at a respective plurality of time instances, receiving cell strength measurement data associated with a given time instance of the plurality of time instances; providing the received cell strength measurement data to the measurement inference model to generate inferred cell strength measurement data for the given time instance; and determining a cell strength measurement result for the given time instance based on the inferred cell strength measurement data.

When the LC device is operating in increased periodicity mode, the method includes receiving configuration for transmitting, to a base station, respective cell strength measurement results corresponding to the respective time instances of the plurality of time instances; and transmitting the inferred cell strength measurement data as the cell strength measurement result for the given time instance without measuring a reference signal from the base station at the given time instance. Additional details about one example of operations that may be associated with this optional step are disclosed herein with reference to FIG. 6. In some examples, the cell strength measurement result is used for link management related decisions for the LC device and the cell strength measurement result may not be transmitted to a base station.

When the LC device is operating in increased accuracy mode, the method includes receiving configuration for transmitting, to a base station, respective cell strength measurement results corresponding to the respective time instances of the plurality of time instances. The method includes, at the given time instance, measuring reference signals from one or more base stations to generate cell strength measurement data for the time instance and refining the cell strength measurement data based on the inferred cell strength measurement data to generate the cell strength measurement result. The cell strength measurement result may be transmitted to the base station. Additional details about one example of operations that may be associated with this optional step are disclosed herein with reference to FIG. 6. In some examples, the cell strength measurement result is used for link management related decisions for the LC device and the cell strength measurement result may not be transmitted to a base station. In one example, the method includes refining the cell strength measurement data by computing a weighted average of the cell strength measurement data and the inferred cell strength measurement data to generate the cell strength measurement result.

Above are several descriptions of flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### Examples

Example 1 is a wireless communication device acting as a management node in a subnetwork, including a memory and a processor coupled to the memory. The processor is configured to, when executing instructions stored in the memory, cause the wireless communication device to receive cell strength measurement data from one or more reference devices belonging to the subnetwork or a management node of a neighboring subnetwork; and broadcast the received cell strength measurement data within the subnetwork.

Example 2 includes the subject matter of example 1, including or omitting optional elements, wherein the cell strength measurement data includes signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of the management node, or one or more downlink beams of the MN of the neighboring subnetwork.

Example 3 includes the subject matter of example 1, including or omitting optional elements, wherein the processor is configured to cause the wireless communication device to aggregate the cell strength measurement data received from the one or more reference devices or the management node of the neighboring subnetwork and broadcast the aggregated cell strength measurement data.

Example 4 includes the subject matter of example 1, including or omitting optional elements, wherein the processor is configured to cause the wireless communication device to broadcast a system information block (SIB) that indicates the cell strength measurement data.

Example 5 includes the subject matter of example 1, including or omitting optional elements, wherein the processor is configured to cause the wireless communication device to transmit the cell strength measurement data via a broadcast message that includes an anonymized identification of respective measurement devices associated with respective cell strength measurement data.

Example 6 includes the subject matter of example 1, including or omitting optional elements, wherein the processor is configured to cause the wireless communication device to determine a respective mobility state for the respective reference devices based on the respective cell strength measurement data.

Example 7 includes the subject matter of example 1, including or omitting optional elements, wherein the processor is configured to cause the wireless communication device to transmit the cell strength measurement data via a broadcast message that also indicates a respective mobility state of respective measurement devices associated with respective cell strength measurement data.

Example 8 includes the subject matter of example 1, including or omitting optional elements, wherein the processor is configured to cause the wireless communication device to control a periodicity of the broadcasting of the received cell strength measurement data within the subnetwork based on a respective mobility state of the respective reference devices.

Example 9 includes the subject matter of example 1, including or omitting optional elements, wherein the processor is configured to cause the wireless communication device to receive cell strength measurement data from another wireless communication device acting as a management node for a different subnetwork; and broadcast the received cell strength measurement data within the subnetwork.

Example 10 is a method for a user equipment (UE), including measuring reference signals transmitted by one or more base stations to generate cell strength measurement data; and transmitting the cell strength measurement data to a management node (MN) of a subnetwork to which the UE belongs.

Example 11 includes the subject matter of example 10, including or omitting optional elements, wherein the cell strength measurement data includes signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of the management node, or one or more downlink beams of a MN of a neighboring subnetwork.

Example 12 includes the subject matter of example 10, including or omitting optional elements, including transmitting the cell strength measurement data via a physical uplink shared channel (PUSCH), physical sidelink shared channel (PSSCH), or a Wi-Fi channel.

Example 13 includes the subject matter of example 10, including or omitting optional elements, including transmitting a mobility status of the UE to the MN.

Example 14 is an apparatus of a user equipment (UE), including one or more baseband processors configured to cause the UE to receive cell strength measurement data representing cell strength measured by reference devices; and determine a cell strength measurement result for the UE based on the received cell strength measurement data.

Example 15 includes the subject matter of example 14, including or omitting optional elements, wherein the one or more baseband processors are configured to cause the UE to receive a broadcast message that includes the cell strength measurement data.

Example 16 includes the subject matter of example 14, including or omitting optional elements, wherein the cell strength measurement data includes signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of a management node of a subnetwork to which the UE belongs, or one or more downlink beams of a MN of a neighboring subnetwork.

Example 17 includes the subject matter of example 14, including or omitting optional elements, wherein the one or more baseband processors are configured to cause the UE to train a measurement inference model by at a plurality of training time instances, measuring reference signals from one or more base stations to generate respective cell strength measurement data; receiving a training set of cell strength measurement data, wherein the training set includes respective cell strength measurement data generated by respective reference devices or management nodes at the plurality of training time instances; and training the measurement inference model based on the training set of cell strength measurement data and the generated cell strength measurement data.

Example 18 includes the subject matter of example 14, including or omitting optional elements, wherein the one or more baseband processors are configured to cause the UE to receive configuration for performing respective cell strength measurements at a respective plurality of time instances; receive cell strength measurement data associated with a given time instance of the plurality of time instances; provide the received cell strength measurement data to a measurement inference model to generate inferred cell strength measurement data for the given time instance; and determine a cell strength measurement result for the given time instance based on the inferred cell strength measurement data.

Example 19 includes the subject matter of example 18, including or omitting optional elements, wherein the one or more baseband processors are configured to cause the UE to receive configuration for transmitting, to a base station, respective cell strength measurement results corresponding to the respective time instances of the plurality of time instances; and transmit the inferred cell strength measurement data as the cell strength measurement result for the given time instance without measuring a reference signal from the base station at the given time instance.

Example 20 includes the subject matter of example 18, including or omitting optional elements, wherein the one or more baseband processors are configured to cause the UE to receive configuration for transmitting, to a base station, respective cell strength measurement results corresponding to the respective time instances of the plurality of time instances; at the given time instance, measure reference signals from one or more base stations to generate cell strength measurement data for the time instance; and refine the cell strength measurement data based on the inferred cell strength measurement data to generate the cell strength measurement result; and transmit the cell strength measurement result to the base station.

Example 21 includes the subject matter of example 20, including or omitting optional elements, wherein the one or more baseband processors are configured to cause the UE to refine the cell strength measurement data by computing a weighted average of the cell strength measurement data and the inferred cell strength measurement data to generate the cell strength measurement result or by selecting either the inferred cell strength measurement data or the cell strength measurement data for the cell strength measurement result based on an impulse response function.

Example 22 includes the subject matter of example 14, including or omitting optional elements, wherein the one or more baseband processors are configured to cause the UE to receive a broadcast message that includes the cell strength measurement data.

Example 23 includes the subject matter of example 22, including or omitting optional elements, wherein the broadcast message includes an anonymized identification of respective measurement devices associated with respective cell strength measurement data.

Example 24 includes the subject matter of example 22, including or omitting optional elements, wherein the broadcast message indicates a respective mobility state of respective measurement devices associated with respective cell strength measurement data.

Example 25 includes the subject matter of example 14, including or omitting optional elements, wherein the one or more baseband processors are configured to cause the UE to receive a system information block (SIB) that indicates the cell strength measurement data.

Example 26 includes the subject matter of example 14, including or omitting optional elements, wherein the one or more baseband processors are configured to cause the UE to control a periodicity of the receiving of the received cell strength measurement data based on a mobility state of the UE.

Example 27 includes the subject matter of example 14, including or omitting optional elements, wherein the one or more baseband processors are configured to cause the UE to trigger a cell re-selection process based on the determined cell strength measurement result.

Example 28 includes the subject matter of example 14, including or omitting optional elements, wherein the one or more baseband processors are configured to cause the UE to transmit a channel state information (CSI) report based on the determined cell strength measurement result.

Example 29 is a method for a user equipment (UE), including receiving cell strength measurement data representing cell strength measured by reference devices; and determining a cell strength measurement result for the UE based on the received cell strength measurement data.

Example 30 includes the subject matter of example 29, including or omitting optional elements, including receiving a broadcast message that includes the cell strength measurement data.

Example 31 includes the subject matter of example 29, including or omitting optional elements, wherein the cell strength measurement data includes signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of a management node of a subnetwork to which the UE belongs, or one or more downlink beams of a MN of a neighboring subnetwork.

Example 32 includes the subject matter of example 29, including or omitting optional elements, including at a plurality of training time instances, measuring reference signals from one or more base stations to generate respective cell strength measurement data; receiving a training set of cell strength measurement data, wherein the training set includes respective cell strength measurement data generated by respective reference devices or management nodes at the plurality of training time instances; and training a measurement inference model based on the training set of cell strength measurement data and the generated cell strength measurement data.

Example 33 includes the subject matter of example 29, including or omitting optional elements, including receiving configuration for performing respective cell strength measurements at a respective plurality of time instances; receiving cell strength measurement data associated with a given time instance of the plurality of time instances; providing the received cell strength measurement data to a measurement inference model to generate inferred cell strength measurement data for the given time instance; and determining a cell strength measurement result for the given time instance based on the inferred cell strength measurement data.

Example 34 includes the subject matter of example 33, including or omitting optional elements, including receiving configuration for transmitting, to a base station, respective cell strength measurement results corresponding to the respective time instances of the plurality of time instances; and transmitting the inferred cell strength measurement data as the cell strength measurement result for the given time instance without measuring a reference signal from the base station at the given time instance.

Example 35 includes the subject matter of example 33, including or omitting optional elements, including receive configuration for transmitting, to a base station, respective cell strength measurement results corresponding to the respective time instances of the plurality of time instances; at the given time instance, measure reference signals from one or more base stations to generate cell strength measurement data for the time instance; and refine the cell strength measurement data based on the inferred cell strength measurement data to generate the cell strength measurement result; and transmit the cell strength measurement result to the base station.

Example 36 includes the subject matter of example 35, including or omitting optional elements, including refining the cell strength measurement data by computing a weighted average of the cell strength measurement data and the inferred cell strength measurement data to generate the cell strength measurement result.

Example 37 is a wireless communication device operating in a subnetwork, including a memory and a processor coupled to the memory. The processor configured is to, when executing instructions stored in the memory, cause the wireless communication device to train a measurement inference model stored in the memory based on a training set of received cell strength measurement data from one or more reference devices belonging to the subnetwork or a neighboring subnetwork; and present subsequently received cell strength measurement data to the trained inference model to generate inferred cell strength measurement data; and perform link management related processing based on the inferred cell strength measurement data.

Example 38 includes the subject matter of example 37, including or omitting optional elements, wherein the inference model includes a linear combination of weighted cell strength measurement data from respective reference devices.

Example 39 includes the subject matter of example 37, including or omitting optional elements, wherein the inference model includes a neural network

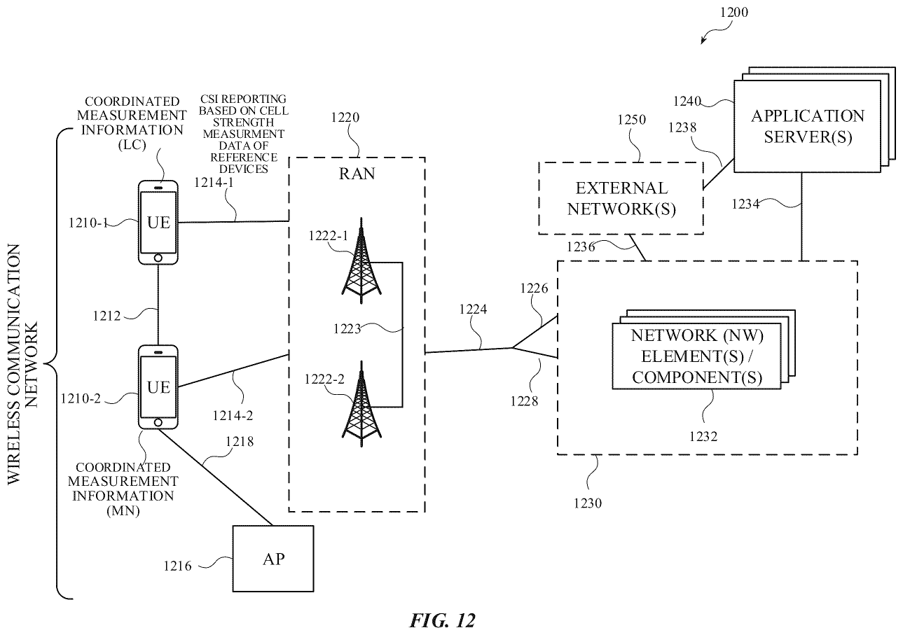

FIG. 12 is an example network 1200 according to one or more implementations described herein. Example network 1200 may include UEs 1210-1, 1210-2, etc. (referred to collectively as “UEs 1210” and individually as “UE 1210”), a radio access network (RAN) 1220, a core network (CN) 1230, application servers 1240, and external networks 1250.

The systems and devices of example network 1200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 1210 may include smartphones (e.g., handheld touchscreen mobile computing devices connectable to one or more wireless communication networks). Additionally, or alternatively, UEs 1210 may include other types of mobile or non-mobile computing devices capable of wireless communications, such as personal data assistants (PDAs), pagers, laptop computers, desktop computers, wireless handsets, watches etc. In some implementations, UEs 1210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 1210 may use one or more wireless channels 1212 to communicate with one another. As described herein, UE 1210-1 may communicate with RAN node 1222 to request sidelink (SL) resources. RAN node 1222 may respond to the request by providing UE 1210 with a dynamic grant (DG) or configured grant (CG) regarding SL resources. A DG may involve a grant based on a grant request from UE 1210. A CG may involve a resource grant without a grant request and may be based on a type of service being provided (e.g., services that have strict timing or latency requirements). UE 1210 may perform a clear channel assessment (CCA) procedure based on the DG or CG, select SL resources based on the CCA procedure and the DG or CG; and communicate with another UE 1210 based on the SL resources. The UE 1210 may communicate with RAN node 1222 using a licensed frequency band and communicate with the other UE 1210 using an unlicensed frequency band.

UEs 1210 may communicate and establish a connection with (e.g., be communicatively coupled) with RAN 1220, which may involve one or more wireless channels 1214-1 and 1214-2, each of which may comprise a physical communications interface/layer.

As described herein, UEs 1210-1, 1210-2 may store coordinated measurement information including configurations and/or instructions for acting as a management node (MN), a reference device, or to determine a measurement result for the UE based on cell strength measurements made by reference devices. The UEs 1210 may provide channel status information (CSI) reporting that is based on cell strength measurements made by reference devices.

As shown, UE 1210 may also, or alternatively, connect to access point (AP) 1216 via connection interface 1218, which may include an air interface enabling UE 1210 to communicatively couple with AP 1216. AP 1216 may comprise a wireless local area network (WLAN), WLAN node, WLAN termination point, etc. The connection 1218 may comprise a local wireless connection, such as a connection consistent with any IEEE 702.11 protocol, and AP 1216 may comprise a wireless fidelity (Wi-Fi®) router or other AP. While not explicitly depicted in FIG. 12, AP 1216 may be connected to another network (e.g., the Internet) without connecting to RAN 1220 or CN 1230.

RAN 1220 may include one or more RAN nodes 1222-1 and 1222-2 (referred to collectively as RAN nodes 1222, and individually as RAN node 1222) that enable channels 1214-1 and 1214-2 to be established between UEs 1210 and RAN 1220. RAN nodes 1222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1222 may include a roadside unit (RSU), a transmission reception point (TRxP or TRP), and one or more other types of ground stations (e.g., terrestrial access points). In some scenarios, RAN node 1222 may be a dedicated physical device, such as a macrocell base station, and/or a low power (LP) base station for providing femtocells, picocells or the like having smaller coverage areas, smaller user capacity, or higher bandwidth compared to macrocells.

The physical downlink shared channel (PDSCH) may carry user data and higher layer signaling to UEs 210. The physical downlink control channel (PDCCH) may carry information about the transport format and resource allocations related to the PDSCH channel, among other things. The PDCCH may also inform UEs 1210 about the transport format, resource allocation, and hybrid automatic repeat request (HARQ) information related to the uplink shared channel. Typically, downlink scheduling (e.g., assigning control and shared channel resource blocks to UE 1210-2 within a cell) may be performed at any of the RAN nodes 1222 based on channel quality information fed back from any of UEs 1210. The downlink resource assignment information may be sent on the PDCCH used for (e.g., assigned to) each of UEs 1210.

As described with reference to FIGS. 1-9, any of the UEs 1210 may implement an AI-based CSI feedback encoder that cooperates with a paired AI-based CSI compression feedback decoder implemented by a RAN node 1222 to transmit the channel quality information in a compressed manner (e.g., compressed CSI feedback).

In some implementations, a downlink resource grid may be used for downlink transmissions from any of the RAN nodes 1222 to UEs 1210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 1222 may be configured to wirelessly communicate with UEs 1210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The RAN nodes 1222 may be configured to communicate with one another via interface 1223. In implementations where the system is an LTE system, interface 1223 may be an X2 interface. In NR systems, interface 1223 may be an Xn interface. The X2 interface may be defined between two or more RAN nodes 1222 (e.g., two or more eNBs/gNBs or a combination thereof) that connect to evolved packet core (EPC) or CN 1230, or between two eNBs connecting to an EPC.

As shown, RAN 1220 may be connected (e.g., communicatively coupled) to CN 1230. CN 1230 may comprise a plurality of network elements 1232, which are configured to offer various data and telecommunications services to customers/subscribers (e.g., users of UEs 1210) who are connected to the CN 1230 via the RAN 1220. In some implementations, CN 1230 may include an evolved packet core (EPC), a 5G CN, and/or one or more additional or alternative types of CNs. The components of the CN 1230 may be implemented in one physical node or separate physical nodes including components to read and execute instructions from a machine-readable or computer-readable medium (e.g., a non-transitory machine-readable storage medium

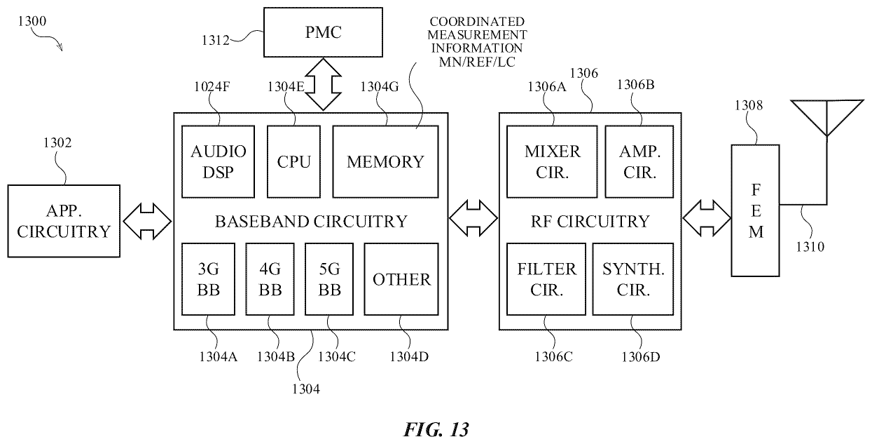

FIG. 13 is a diagram of an example of components of a network device (e.g., a device acting as a management node, reference device, or low capability device of FIGS. 1-8) according to one or more implementations described herein. In some implementations, the device 1300 can include application circuitry 1302, baseband circuitry 1304, RF circuitry 1306, front-end module (FEM) circuitry 1308, one or more antennas 1310, and power management circuitry (PMC) 1312 coupled together at least as shown. The components of the illustrated device 1300 can be included in a UE or a RAN node. In some implementations, the device 1300 can include fewer elements (e.g., a RAN node may not utilize application circuitry 1302, and instead include a processor/controller to process IP data received from a CN or an Evolved Packet Core (EPC)). In some implementations, the device 1300 can include additional elements such as, for example, memory/storage, display, camera, sensor (including one or more temperature sensors, such as a single temperature sensor, a plurality of temperature sensors at different locations in device 1300, etc.), or input/output (I/O) interface. In other implementations, the components described below can be included in more than one device (e.g., said circuitries can be separately included in more than one device for Cloud-RAN (C-RAN) implementations).

The application circuitry 1302 can include one or more application processors. For example, the application circuitry 1302 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1300. In some implementations, processors of application circuitry 1302 can process IP data packets received from an EPC.

The baseband circuitry 1304 can include circuitry such as, but not limited to, one or more single-core or multi-core processors. The baseband circuitry 1304 can include one or more baseband processors or control logic to process baseband signals received from a receive signal path of the RF circuitry 1306 and to generate baseband signals for a transmit signal path of the RF circuitry 1306. Baseband circuitry 1304 can interface with the application circuitry 1302 for generation and processing of the baseband signals and for controlling operations of the RF circuitry 1306. For example, in some implementations, the baseband circuitry 1304 can include a 3G baseband processor 1304A, a 4G baseband processor 1304B, a 5G baseband processor 1304C, or other baseband processor(s) 1304D for other existing generations, generations in development or to be developed in the future (e.g., 5G, 6G, etc.).

The baseband circuitry 1304 (e.g., one or more of baseband processors 1304A-D) can handle various radio control functions that enable communication with one or more radio networks via the RF circuitry 1306. In other implementations, some or all of the functionality of baseband processors 1304A-D can be included in modules stored in the memory 1304G and executed via a Central Processing Unit (CPU) 1304E. In some implementations, the baseband circuitry 1304 can include one or more audio digital signal processor(s) (DSP) 1304F.

In some implementations, memory 1304G may receive and/or store configuration and/or instructions for acting as a management node, a reference device, or a low capability device as described with reference to FIGS. 1-8.

RF circuitry 1306 can enable communication with wireless networks using modulated electromagnetic radiation through a non-solid medium. In various implementations, the RF circuitry 1306 can include switches, filters, amplifiers, etc. to facilitate the communication with the wireless network. RF circuitry 1306 can include a receive signal path which can include circuitry to down-convert RF signals received from the FEM circuitry 1308 and provide baseband signals to the baseband circuitry 1304. RF circuitry 1306 can also include a transmit signal path which can include circuitry to up-convert baseband signals provided by the baseband circuitry 1304 and provide RF output signals to the FEM circuitry 1308 for transmission.

In some implementations, the receive signal path of the RF circuitry 1306 can include mixer circuitry 1306A, amplifier circuitry 1306B and filter circuitry 1306C. In some implementations, the transmit signal path of the RF circuitry 1306 can include filter circuitry 1306C and mixer circuitry 1306A. RF circuitry 1306 can also include synthesizer circuitry 1306D for synthesizing a frequency for use by the mixer circuitry 1306A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for coordinated measurements within a subnetwork according to implementations and examples described.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A wireless communication device acting as a management node in a subnetwork, comprising:
a memory; and
a processor coupled to the memory, the processor configured to, when executing instructions stored in the memory, cause the wireless communication device to:
receive cell strength measurement data from one or more reference devices belonging to the subnetwork or a management node of a neighboring subnetwork; and
broadcast the received cell strength measurement data within the subnetwork.

2. The wireless communication device of claim 1, wherein the cell strength measurement data comprises signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of the management node, or one or more downlink beams of the MN of the neighboring subnetwork.

3. The wireless communication device of claim 1, wherein the processor is configured to cause the wireless communication device to aggregate the cell strength measurement data received from the one or more reference devices or the management node of the neighboring subnetwork and broadcast the aggregated cell strength measurement data.

4. The wireless communication device of claim 1, wherein the processor is configured to cause the wireless communication device to broadcast a system information block (SIB) that indicates the cell strength measurement data.

5. The wireless communication device of claim 1, wherein the processor is configured to cause the wireless communication device to transmit the cell strength measurement data via a broadcast message that includes an anonymized identification of respective measurement devices associated with respective cell strength measurement data.

6. The wireless communication device of claim 1, wherein the processor is configured to cause the wireless communication device to determine a respective mobility state for the respective reference devices based on the respective cell strength measurement data.

7. The wireless communication device of claim 1, wherein the processor is configured to cause the wireless communication device to transmit the cell strength measurement data via a broadcast message that also indicates a respective mobility state of respective measurement devices associated with respective cell strength measurement data.

8. The wireless communication device of claim 1, wherein the processor is configured to cause the wireless communication device to control a periodicity of the broadcasting of the received cell strength measurement data within the subnetwork based on a respective mobility state of the respective reference devices.

9. The wireless communication device of claim 1, wherein the processor is configured to cause the wireless communication device to
receive cell strength measurement data from another wireless communication device acting as a management node for a different subnetwork; and
broadcast the received cell strength measurement data within the subnetwork.

10. A method for a user equipment (UE), comprising:
measuring reference signals transmitted by one or more base stations to generate cell strength measurement data; and
transmitting the cell strength measurement data to a management node (MN) of a subnetwork to which the UE belongs.

11. The method of claim 10, wherein the cell strength measurement data comprises signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of the management node, or one or more downlink beams of a MN of a neighboring subnetwork.

12. The method of claim 10, comprising transmitting the cell strength measurement data via a physical uplink shared channel (PUSCH), physical sidelink shared channel (PSSCH), or a Wi-Fi channel.

13. The method of claim 10, comprising transmitting a mobility status of the UE to the MN.

14. An apparatus of a user equipment (UE), comprising one or more baseband processors configured to cause the UE to:
receive cell strength measurement data representing cell strength measured by reference devices; and
determine a cell strength measurement result for the UE based on the received cell strength measurement data.

15. The apparatus of claim 14, wherein the one or more baseband processors are configured to cause the UE to receive a broadcast message that includes the cell strength measurement data.

16. The apparatus of claim 14, wherein the cell strength measurement data comprises signal to interference and noise (SINR) data, reference signal received power (RSRP) data, or reference signal received quality (RSRQ) data for one or more downlink beams of a serving base station of a respective reference device, one or more downlink beams of a neighboring base station of a respective reference device, one or more downlink beams of a management node of a subnetwork to which the UE belongs, or one or more downlink beams of a MN of a neighboring subnetwork.

17. The apparatus of claim 14, wherein the one or more baseband processors are configured to cause the UE to train a measurement inference model by
at a plurality of training time instances, measuring reference signals from one or more base stations to generate respective cell strength measurement data;
receiving a training set of cell strength measurement data, wherein the training set comprises respective cell strength measurement data generated by respective reference devices or management nodes at the plurality of training time instances; and
training the measurement inference model based on the training set of cell strength measurement data and the generated cell strength measurement data.

18. The apparatus of claim 14, wherein the one or more baseband processors are configured to cause the UE to
receive configuration for performing respective cell strength measurements at a respective plurality of time instances;
receive cell strength measurement data associated with a given time instance of the plurality of time instances;
provide the received cell strength measurement data to a measurement inference model to generate inferred cell strength measurement data for the given time instance; and
determine a cell strength measurement result for the given time instance based on the inferred cell strength measurement data.

19. The apparatus of claim 18, wherein the one or more baseband processors are configured to cause the UE to
receive configuration for transmitting, to a base station, respective cell strength measurement results corresponding to the respective time instances of the plurality of time instances; and
transmit the inferred cell strength measurement data as the cell strength measurement result for the given time instance without measuring a reference signal from the base station at the given time instance.

20. The apparatus of claim 18, wherein the one or more baseband processors are configured to cause the UE to
receive configuration for transmitting, to a base station, respective cell strength measurement results corresponding to the respective time instances of the plurality of time instances;
at the given time instance, measure reference signals from one or more base stations to generate cell strength measurement data for the time instance; and
refine the cell strength measurement data based on the inferred cell strength measurement data to generate the cell strength measurement result; and
transmit the cell strength measurement result to the base station.

21. The apparatus of claim 20, wherein the one or more baseband processors are configured to cause the UE to refine the cell strength measurement data by computing a weighted average of the cell strength measurement data and the inferred cell strength measurement data to generate the cell strength measurement result or by selecting either the inferred cell strength measurement data or the cell strength measurement data for the cell strength measurement result based on an impulse response function.
